(19) United States
(12) Patent Application Publication
(10) Pub. No.: US 2004/0039928 A1
(43) Pub. Date: Feb. 26, 2004

(54) Cryptographic processor

(76) Inventors: Astrid Elbe, Munchen (DE); Norbert Janssen, Munchen (DE); Holger Sedlak, Sauerlach (DE)

Correspondence Address: LERNER AND GREENBERG, P.A., POST OFFICE BOX 2480, HOLLYWOOD, FL, 33022-2480, US

(21) Appl. No.: 10/461,913

(22) Filed: Jun. 13, 2003

Related U.S. Application Data
(63) Continuation of application No. PCT/EP01/13279, filed on Nov. 16, 2001.

(30) Foreign Application Priority Data
Dec. 13, 2000 (DE) 100 61 998.3

(51) Int. Cl. H04L 9/00

(52) U.S. Cl. 713/189

(57) ABSTRACT

A cryptographic processor for performing operations for cryptographic applications comprises a plurality of coprocessors, each coprocessor having a control unit and an arithmetic unit, a central processing unit for controlling said plurality of coprocessors and a bus for connecting each coprocessor to the central processing unit. The central processing unit, the plurality of coprocessors and the bus are integrated an one single chip. The chip further comprises a common power supply terminal for feeding said plurality of coprocessors. By way of parallel connection of various coprocessors, there is obtained an the one hand an increase in throughput and an the other hand an improvement in security of the cryptographic processor with respect to attacks that are based an the evaluation of power profiles of the cryptographic processor, since power profiles of a least two coprocessors are superimposed. Furthermore, the cryptographic processor, by utilization of different coprocessors, may also be implemented as a multifunctional cryptographic processor so as to be suitable for a multiplicity of different cryptographic algorithms.

### CROSS-REFERENCE TO RELATED APPLICATION

This application is a continuation of copending International Application No. PCT/EP01/13279, filed Nov. 16, 2001, which designated the United States and was not published in English.

### FIELD OF THE INVENTION

The present invention relates to cryptographic techniques and in particular to the architecture of cryptographic processors utilized for cryptographic applications.

### BACKGROUND OF THE INVENTION AND PRIOR ART

With the increasing advent of cashless payment traffic, electronic data transmission via public networks, exchange of credit card numbers via public networks and, generally speaking, the use of so-called smart cards for the purposes of payment, identification or access, there is created an ever increasing demand for cryptographic techniques. Cryptographic techniques, an the one hand, comprise cryptographic algorithms and, an the other hand, suitable processor solutions carrying out the computations prescribed by the cryptographic algorithms. In contrast to former times, when cryptographic algorithms were carried out on general purpose computers, the costs, the required computation time and the security with respect to a huge variety of external attacks were of no such great significance as today, where cryptographic algorithms are implemented increasingly an chip cards or special security ICs that are subject to specific requirements. For example, such smart cards must be available an the one hand at low cost, as they are mass products, but an the other hand must display high security with respect to external attacks as they are completely in the power of the potential attacker.

In addition thereto, cryptographic processors must provide considerable computation capacity, especially as the security of many cryptographic algorithms, such as e.g. the known RSA algorithm, is decisively dependent an the length of the keys used. Expressed in other words, this means that with increasing length of the numbers to be processed, security is increased as well, since an attack based an trial of all possibilities is rendered impossible for reasons of computation time.

Expressed in the form of numerical values, this means that cryptographic processors have to be capable of handling integers, i.e. complete numbers, having a length of maybe 1024 bits, 2048 bits or maybe still more. In comparison therewith, processors in a conventional PC are processing 32 bit or 64 bit integers. Just in case of computation using elliptic curves, is the number of positions for lower values in the range of 160 positions, which however still is clearly above the number of positions in conventional PCs.

However, high computation expenditure at the same time means long computation time, so that cryptographic processors at the same time are subject to the fundamental requirement of achieving high computation throughput so that, for example, an identification, access to a building, a payment transaction or a credit card transmission does not take many minutes, which would be very detrimental for market acceptance.

Thus, it may be summarized that cryptographic processors must be secure, fast and therefore extraordinarily powerful.

One possibility of increasing the throughput through a processors consists in providing a central processing unit with one or more coprocessors operating in parallel, as is the case e.g. in modern PCs or also modern graphics cards. Such a scenario is illustrated in FIG. 7. FIG. 7 shows a printed circuit computer board 800 having arranged thereon a CPU 802, a working memory (RAM) 804, a first coprocessor 806, a second coprocessor 808 as well as a third coprocessor 810. CPU 802 is connected to the three coprocessors 806, 808, 810 via a bus 812. Furthermore, there may be provided a separate memory for each coprocessor, that serves for operations of the particular coprocessor only, i.e. a memory 1 814, a memory 2 816 for coprocessor 2 as well as a memory 3 818 for coprocessor 3.

In addition thereto, each chip arranged an the computer board 800 illustrated in FIG. 7 is fed with the electrical power necessary for the functioning of the electronic components within the individual elements via a separate power or voltage supply terminal I₁ to I₈. As an alternative, the printed circuit board may be provided with one single power supply only which then is distributed across the board to the individual chips an the board. However, the supply lines to the individual chips, however, would be available to an attacker.

The concept for usual computer applications as shown in FIG. 7 is unsuitable for cryptographic processors for several reasons. On the one hand, all elements are designed for short integer arithmetic, whereas cryptographic processors have to perform long integer arithmetic operations.

In addition thereto, each chip an computer board 800 has a current or power access of its own, which may easily be accessed by an attacker for tapping power profiles or current profiles over time. The tapping of power profiles over time is the basis of a multiplicity of efficient attacks against cryptographic processors. Additional background information and a detailed representation of various attacks against cryptographic processors are given in “Information Leakage Attacks Against Smart Card Implementations of Cryptographic Algorithms and Countermeasures”, Hess et al., Eurosmart Security Conference, Jun. 13 to 15, 2000. The countermeasures suggested are implementations based an the fact that different operations always take the same time, so that it is not possible for an attacker to see an the basis of a power profile whether the cryptographic processor has carried out a multiplication, an addition or anything else.

The article “Design of Long Integer Arithmetic Units for 10 Public Key Algorithms”, Hess et al., Eurosmart Security Conference, Jun. 13 to 15, 2000, discusses several arithmetic operations which cryptographic processors must be able of performing. Reference is made in particular to modular multiplication, methods of modular reduction as well as the so-called ZDN process indicated in German patent DE 36 31 992 C2.

The ZDN process is based an a serial/parallel architecture using look-ahead algorithms for multiplication and modular reduction that can be carried out in parallel, in order to transform a multiplication of two binary numbers to an iterative 3-operand addition using look-ahead parameters for the multiplication and the modular reduction. To this end, the modular multiplication is broken down into a serial computation of partial products. At the beginning of the iteration, two partial products are formed and then added up in consideration of the modular reduction, in order to obtain an intermediate result. Thereafter, another partial product is formed and added to said intermediate result, again in consideration of the modular reduction. This iteration is continued until all positions of the multiplier have been processed. For a three-operand addition, a crypto coprocessor comprises an adder which, in a current iteration step, carries out the summation of a new partial product to the intermediate result of the preceding iteration step.

Thus, each coprocessor of FIG. 7 could be provided with a ZDN unit of its own in order to carry out several modular multiplications in parallel, in order to increase the throughput for specific applications. However, this solution again would be subject to failure as an attacker could find out the current profiles of each individual chip, so that an increase in throughput indeed has been achieved, however at the expense of the security of the cryptographic computer.

The document WO 99/39475 A1 discloses a cryptographic Sys tem comprising a connector, a bus interface and a processing board having arranged thereon a cryptographic processor, a coprocessor adapted to be reconfigured, two cryptographic coprocessors, a RAM memory and an EE-flash memory. The cryptographic processor an the processing board is provided furthermore with a battery.

U.S. Pat. No. 6,101,255 discloses a programmable cryptographic processing system comprising a key management crypto processor, a crypto control and a programmable processor having a programmable cryptographic processor and a configurable cryptographic processor. All of the components mentioned are integrated an one single chip. The security for the key management is already obtained due to the Integration since structures to be uncovered by an attacker are in the sub-micron range. Furthermore, there is provided a protective covering that aggravates drawing upon the chip surface in order to spy out signals.

### SUMMARY OF THE INVENTION

It is the object of the present invention to make available a fast and secure cryptographic processor.

In accordance with the present invention, this object is achieved by a cryptographic processor for performing operations for cryptographic applications, comprising: a plurality of coprocessors, each coprocessor having a control unit, an arithmetic unit and a plurality of registers exclusively associated with said arithmetic unit of the respective coprocessor, each coprocessor having a word length which is predetermined by the number width of the respective arithmetic unit; a central processing unit for controlling said plurality of coprocessors, said central processing unit being arranged to couple at least two coprocessors in such a way that the registers exclusively associated with them are interconnected so that the coupled coprocessors can perform a calculation with numbers the word length of which equals the sum of the number widths of said arithmetic units of said coupled coprocessors; and a bus for connecting each coprocessor to the central processing unit, said central processing unit, said plurality of coprocessors and said bus being integrated on one single chip, and said chip having a common power supply terminal for feeding said plurality of coprocessors.

The present invention is based an the finding that one must depart from the conventional approach of rendering parallel cryptographic operations. Cryptographic processors according to the present invention are implemented an one single chip. A plurality of coprocessors is connected via a bus to a central processing unit, with all of the coprocessors having power supplied thereto from one common power supply terminal. It is then possible for an attacker with very high difficulties only, or even not at all, to “eavesdrop” the operations of the individual coprocessors by way of a power profile at the power supply terminal. For increasing the throughput of the cryptographic processor, the coprocessors are connected in parallel to the central processing unit via the bus, such that an arithmetic operation can be distributed to the individual coprocessors by the central processing unit (CPU).

Preferably, there are several different types of coprocessors integrated an the single chip, so that the cryptographicprocessor can be utilized as multifunctional cryptographic processor. This means in other words that a coprocessor or a group of coprocessors, respectively, is designed for asymmetric encryption processes, such as e.g. the RSA algorithm. Again other crypto coprocessors are provided to carry out arithmetic operations which are necessary e.g. for DES encryption processes. Another coprocessor or several additional coprocessors constitute e.g. an AES module to be able to perform symmetric encryption processes, whereas still other coprocessors constitute e.g. a Hash module in order to compute Hash values. In this manner, a secure multifunctional cryptographic processor is obtained which, when comprising a corresponding number of crypto coprocessors, may be utilized for many different encryption processes. Such a multifunctional cryptographic processor is advantageous in particular for server applications, e.g. in the Internet, to the effect that one server is capable of performing many different encryption tasks.

However, multifunctionality is of advantage for smart cards as well, especially as there are various encryption concepts available in parallel or become increasingly common. Thus, a smart card will be successful in the market if it can perform many different functionalities, as compared to a concept with many different smart cards for many different operations, since a smart card holder merely has to carry in his wallet just one single smart card and not, for example, 10 different smart cards for 10 different applications.

In addition thereto, the cryptographic processor according to the invention does not only provide for multifunctionality, but in addition thereto also higher security. The higher security is, so to speak, a “waste product” of the multifunctionality, as the various cryptographic algorithms have different operations and thus different power profiles. Even if only one crypto coprocessor at a time performs a type of algorithm and the other crypto coprocessors are at rest, since they have not been addressed, there is an additional barrier present for an attacker, to the effect that the same must find out first which particular type of algorithm is active at that time, before he can analyze the individual power profile. The situation becomes considerably more difficult for the attacker if there are two cryptographic coprocessor types operating in parallel, as power profiles of two completely different types of algorithms then are superimposed an each other an the common power supply terminal.

This scenario in principle can be obtained at all times when the crypto coprocessor is designed such that one type of crypto coprocessors performs so to speak a “dummy” computation, even if only one single other crypto coprocessor type is addressed. If the “dummy” crypto coprocessor is selected by chance, it will become still harder for an attacker to find out parameters of the “useful” crypto coprocessor algorithm, as he does not know, even if the same useful algorithm is carried out at all times, which other module is operating at the particular time. Security thus increases with the number of different crypto coprocessors an the cryptographic processor chip.

### BRIEF DESCRIPTION OF THE DRAWINGS

Preferred embodiments of the present invention will be elucidated in detail hereinafter with reference to the accompanying drawings in which

FIG. 1 shows a cryptographic processor according to the invention that is integrated an one single chip;

FIG. 2 shows a more detailed illustration of the plurality of independent coprocessors controlled by a CPU;

FIG. 3 shows a more detailed illustration of an arithmetic unit suitable for three-operand addition;

FIG. 4a shows a schematic flow chart for performing modular multiplication in serial/parallel manner;

FIG. 4b shows a numerical example for illustrating the serial/parallel operation of an arithmetic unit by way of a multiplication;

FIG. 5 shows an example for splitting a modular exponentiation to a number of modular multiplications;

FIG. 6 shows another example of splitting a modular exponentiation to various coprocessors; and

FIG. 7 shows a computer board with a multiplicity of separately fed components.

### DETAILED DESCRIPTION OF PREFERRED EMBODIMENTS

Before making more detailed reference to the individual figures, it will be pointed out in the following why higher security is obtained by parallel connection of several coprocessors that are arranged an one chip and controlled by one control unit arranged an the same chip.

Cryptographic processors are utilized for applications of crucial security, for example for digital signatures, authentication or encryption tasks. An attacker, for example, intends to find out the secret key in order to thus break the cryptographic scheme. Cryptographic processors are used, for example, in chip cards which, as was already pointed out hereinbefore, comprise smart cards or signature cards for a legally binding electronic signature or also for home banking or payment using a mobile telephone, etc. As an alternative, such cryptographic processors are also utilized in computers and servers as security IC, in order to carry out an authentication or for being able to perform encryption tasks that may consist, for example, in secure payment via the Internet, in so-called SSL sessions (SSL=secure socket layer), i.e. the secure transmission of credit card numbers.

Typical physical attacks measure the power consumption (SPA, DPA, timing attacks) or the electromagnetic radiation. For closer elucidation of the attacks, reference is made to the initially indicated literature sources.

Due to the fact that, with present-day semiconductor technology obtaining structures in the range of typically less than or equal to 250 nanometers, attackers can carry out local current measurements with very great difficulties only, an attack typically involves the measurement of the power consumption of the entire chip card inclusive of CPU and coprocessor, which consists of the sum of the individual power consumption of, for example, the CPU, the RAM, a ROM, an E2PROM, a flash memory, a time control unit, a random number generator (RNG), a DES module and the crypto coprocessor.

Due to the fact that crypto coprocessors typically involve the highest power consumption, an attacker is able to see when the individual crypto coprocessors start computing as the respective coprocessors are individually fed with power. To avoid this, the aim would be a power consumption that is completely constant over time, as an attacker then would no longer recognize when a crypto coprocessor starts computing. This ideal aim cannot be achieved, but the parallel connection of coprocessors according to the invention strives at, and attains, an as uniform as possible “noise” around an average value.

The power consumption of a chip, implemented for example in CMOS technology, changes upon switching over from a “0” to a “1”. The power consumption thus is data-dependent as well as dependent an the commands used by the CPU and the crypto coprocessors.

If several coprocessors are connected in parallel and these are caused to process several operations or partial operations in parallel, or if an operation is split to several coprocessors, the current profiles caused by processing of the data and commands, as pointed out, are superimposed an each other.

The larger the number of coprocessors working in parallel, the more difficult it becomes to make conclusions as to data and commands in the individual coprocessors and in the control unit, respectively, since the data and commands in each coprocessor will usually be different, whereas the attacker just perceives the superimposition of different commands, but not the current profiles having their origin in individual commands.

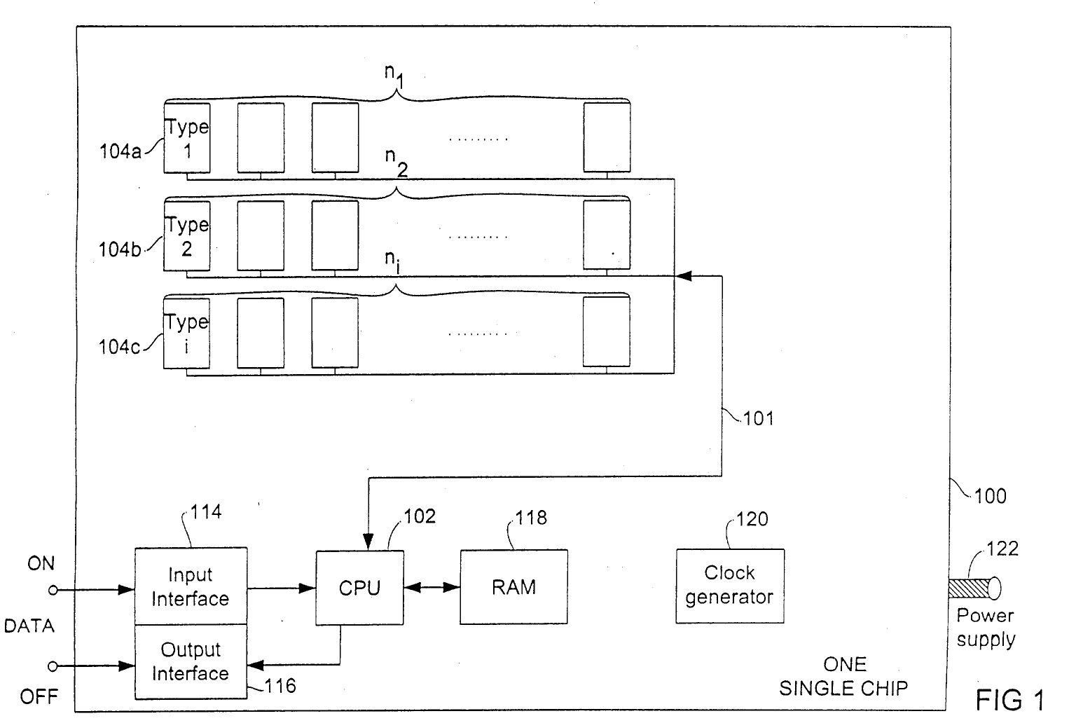

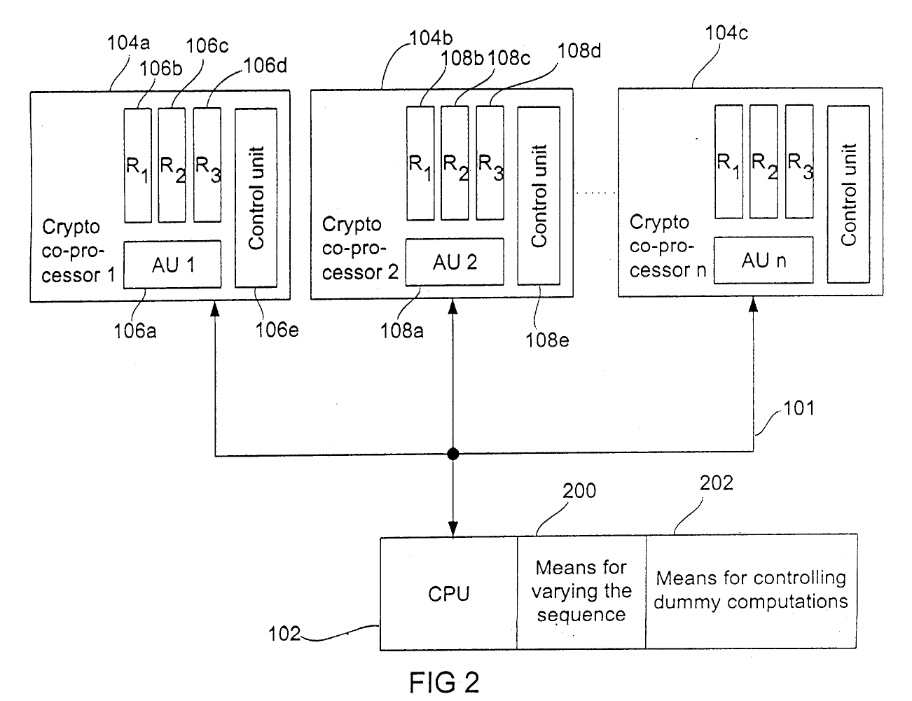

FIG. 1 illustrates a cryptographic processor according to the invention, for performing operations for cryptographic applications. The cryptographic processor is implemented an one single chip 100 and comprises a central processing unit (CPU) 102 and a plurality of coprocessors 104a, 104b, 104c. The coprocessors, as shown in FIG. 1, are arranged an the same chip as the central processing unit 102. Each coprocessor of the plurality of coprocessors comprises an arithmetic unit of its own. Preferably, each coprocessor 104a, 104b, 104c, in addition to the arithmetic unit, at least one register (REG) each in order to be able to store intermediate results, as will be described with reference to FIG. 2.

A typical cryptographic processor will comprise an input interface 114 and an output interface 116, which are connected to external terminals for data input and data Output, respectively, as well as to CPU 102. CPU 102 typically has a memory 118 of its own associated therewith, which is designated RAM in FIG. 1. The cryptographic processor, among other things, may comprise a clock generator 120, further memories, random number generators etc. that are not shown in FIG. 1.

It is to be pointed out that all elements illustrated in FIG. 1 are implemented an one single chip that is fed with power from one single power supply terminal 122. Chip 100 has internal power supply lines to all elements shown in FIG. 1, which however cannot be tapped individually for the reasons indicated hereinbefore.

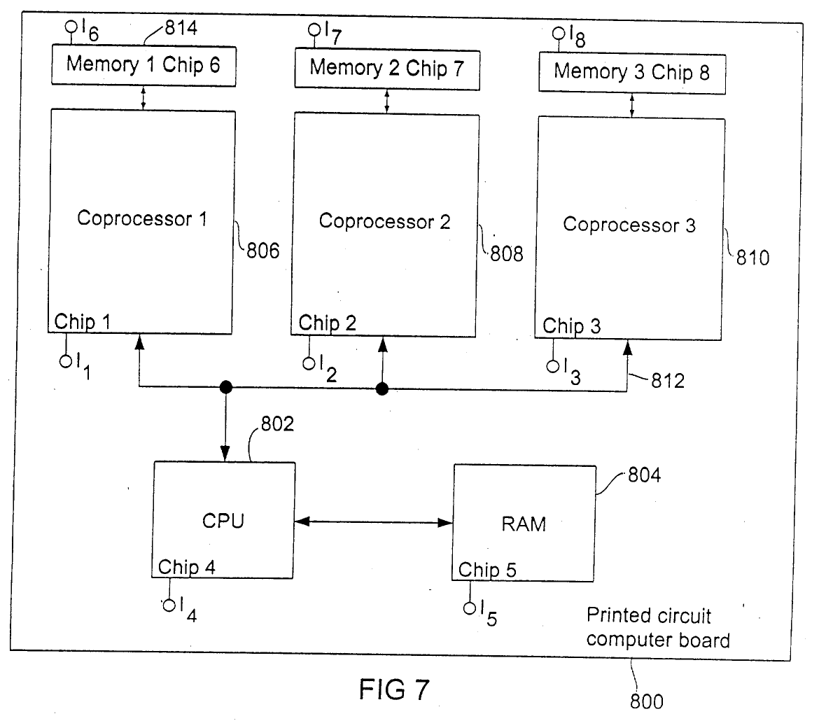

In contrast thereto, it is easily possible to tap the current supply terminal 122. Contrary to the printed circuit board shown in FIG. 7, in which the power supply terminals of all individual components can be tapped very easily and thus have very “expressive” current profiles, the current profile present at power supply terminal 122 is nearly constant or involves as homogenous noise as possible around a constant value. This is due to the fact that the coprocessors 104a, 104b, 104c, contributing most in current consumption, switch over e.g. from “0” to “1” independently of each other upon corresponding control or corresponding implementation thereof, and thus consume current in non-correlated manner.

The parallel connection of the individual coprocessors, furthermore, has the effect that the throughput of the cryptographic processor can be increased so that, in case of implementation of a memory an the chip, the concomitant losses in speed, occurring due to different technologies for memories and arithmetic-logic units, can be more than compensated.

As was already pointed out, the cryptographic processor of FIG. 1 comprises a CPU 102 connected to a plurality of crypto coprocessors 104a, 104b, 104c via a bus 101. According to the invention, homogenization of the power profile at the common power supply terminal 122 is already achieved by two mutually separate, independent crypto coprocessors 104a and 104b. Security is enhanced if the two crypto coprocessors 104a and 104b are of different design, i.e. either are capable of performing different partial operations of an arithmetic operation or have arithmetic-logic units for various cryptographic algorithms, such as e.g. for asymmetric encryption processes (e.g. RSA), symmetric encryption processes (DES, 3DES or AES), Hash modules for computing Hash values and the like. Throughput is increased if a plurality of crypto coprocessors is connected in parallel for Bach algorithm type. FIG. 1, for example, shows crypto coprocessors connected in parallel, which are all implemented to carry out e.g. operations appearing in RSA algorithms. The second coprocessor line of FIG. 1 shows n₂ complete, independent crypto coprocessors that are all implemented, for example, for arithmetic operations required for DES algorithms. Finally, the third crypto coprocessor line in FIG. 1 illustrates nᵢ independent crypto coprocessors that are all implemented for operations required, for example, for Hash computations. It is thus possible to obtain a considerable increase in throughput for the different cryptographic algorithms and operations, respectively, that are necessary for the same, if these operations or tasks set by the cryptographic algorithm can be distributed to parallel, independent arithmetic-logic units.

Such a multifunctional cryptographic processor, comprising a plurality of crypto coprocessors for different jobs, may also be used to advantage if the cryptographic processor illustrated in FIG. 1, which is implemented e.g. an a smart card, is controlled such that it has to process only one cryptographic algorithm. Advantageously, the CPU is implemented such that, in this event, it drives an actually quiescent crypto coprocessor to cause the same to perform “dummy” computations, so that an attacker at power supply input 122 perceives at least two superimposed power profiles. The crypto coprocessor type performing dummy computations is selected advantageously in random manner, so that an attacker, even if the same has found out which coprocessor type carries out the useful computations, will never know which crypto coprocessor type is carrying out dummy computations at the particular time; there is, so to speak, a “dummy power profile” superimposed an the “useful power profile” at the common power supply terminal.

FIG. 2 shows a more detailed illustration of crypto coprocessors 104a, 104b and 104c. As shown in FIG. 2, the independent crypto coprocessor 104a comprises an arithmetic unit 106a, three registers 106b to 106d as well as a control unit 106a of its own. The same holds for crypto coprocessor 104b, which also has an arithmetic unit 108a, for example three registers 108b to 108d as well as a control unit 108e of its own. Crypto coprocessor 104c has a construction analogously therewith.

Furthermore, FIG. 2 schematically shows the means for varying the sequence 200 as part of the CPU. The same holds for a means 202 for controlling dummy computations, which is shown as part of the CPU 102 as well. In a preferred embodiment of the present invention, means 202 is arranged for selecting in random manner the crypto coprocessor or the type of crypto coprocessors that is to carry out the dummy computations parallel to the useful computation of another crypto coprocessor type.

As regards the various cryptographic algorithms and the hardware implementations thereof, respectively, reference is made to the “Handbook of Applied Cryptography”, Menezes, van Oorschoot and Vanstone, CRC Press, 1997.

According to a preferred embodiment, the control unit 105 may control the two coprocessors 106 and 108, for example, also such that the arithmetic units AU₁ and AU₂ are coupled to each other such that both coprocessors, which then constitute a cluster, carry out arithmetic operations with numbers of a length of L₁+L₂. The registers of the two coprocessors may thus be connected in common.

As an alternative, it is however also possible to assign to a coprocessor a number of registers in exclusive manner, which is of such an extent that the operands are sufficient for several partial operations, such as e.g. modular multiplications or modular exponentiations. For avoiding Information leaks, the partial operations then may be superimposed or even be mixed in random manner, for example by a means for varying the sequence thereof, which is designated 200 in FIG. 2, in order to thus obtain further obscuring of the current profile. This will be advantageous in particular when, for example, only two coprocessors are provided or only two coprocessors are in operation, respectively, whereas the other coprocessors of a cryptographic processors are inoperative at the particular moment.

According to a preferred embodiment of the present invention, the control unit 105 comprises furthermore a means, not shown in FIG. 2, for deactivating coprocessors or registers of coprocessors, respectively, when these are not required, which may be advantageous in particular for battery-powered applications for reducing the current consumption of the overall circuit. It is true that CMOS components need current to a significant extent only during switching over, but they also have a quiescent state current consumption that may be of relevance if the power available is limited.

As was already pointed out, a cryptographic processor, due to the long integers to be processed by the same, has the property that specific partial operations, such as e.g. serial/parallel multiplication as illustrated with reference to FIGS. 4a and 4b, require quite a long time. The coprocessors preferably are designed such that they are able to perform such a partial operation independently, without interference by the control unit 105, after the control unit has issued the necessary command to the arithmetic-logic unit. To this end, each coprocessor of course requires registers for storing the intermediate solutions.

Due to the fact that a coprocessor, without input by the CPU 102, is in operation for a relatively long period of time, the CPU 102 may apply the necessary commands to a multiplicity of individual coprocessors so to speak in serial manner, i.e. successively, such that all coprocessors are in operation in parallel, but in somewhat time-shifted manner relative to each other.

For example, the first coprocessor is activated at a specific time. When the CPU 102 has completed the activation of the first coprocessor, it will immediately carry out the activation of the second coprocessor while the first coprocessor is already in operation. The third coprocessor is activated upon completion of the activation of the second coprocessor. This means that, during activation of the third coprocessor, the first and second coprocessors are already computing. When this is carried out for all n coprocessors, all coprocessors are in operation in time-shifted manner. If all coprocessors are operating such that their partial operations have the same duration, the first coprocessor will have finished first.

The CPU may now obtain the results from the first coprocessor and ideally has completed this before the second coprocessor has finished. The throughput can thus be increased considerably, with an optimum exploitation of the computing capacity of the CPU 102 being achieved as well. Though all coprocessors carry out identical operations, there is nevertheless created a highly obscured current profile as all coprocessors operate in time-shifted manner. The situation would be different if all coprocessors are activated by the CPU at the same time and work in completely synchronous manner in a way. This would lead to a non-obscured current profile and an even enhanced current profile. The serial activation of the coprocessors thus is advantageous with regard to the security of the cryptographic processor as well.

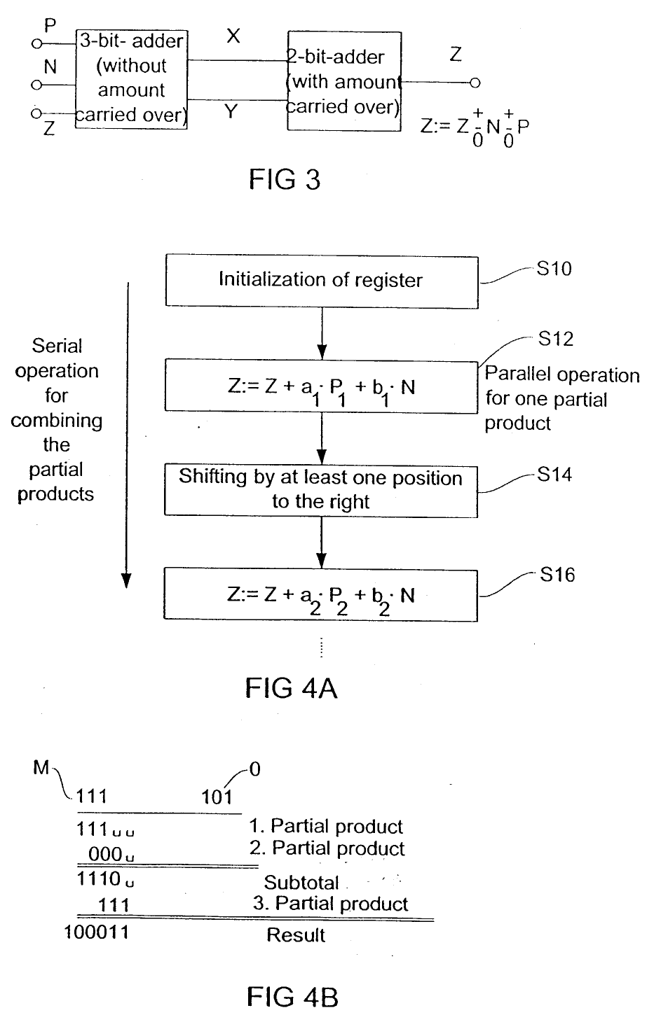

In the following, FIG. 3 shall be dealt with, which illustrates a device for carrying out a three-operand addition as illustrated as a formula to the right in FIG. 3. The formula to the right in FIG. 3 illustrates that addition and subtraction are carried out alike, as an operand just has to be multiplied by the factor “−1” in order to arrive at a subtraction. The three-operand addition is carried out by means of a three-bit adder working without amount carried over, i.e. a half-adder, and a downstream two-bit adder working with an amount carried over, i.e. which is a full adder. Alternatively, there may also be the case that only operand N, only operand P or no operand at all is to be added to, or subtracted from, operand Z. This is indicated symbolically in FIG. 3 by the “zero” under the plus/minus sign and by way of the so-called look-ahead Parameters a₁, b₁ indicated in FIG. 4, which are computed anew in each iteration step.

FIG. 3 illustrates a so-called bit slice of such an adder. For the addition of three numbers with, for example, 1024 binary positions, the arrangement illustrated in FIG. 3 would be present 1024 times in the arithmetic unit of an arithmetic-logic unit 106 for completely parallel Operation.

In a preferred embodiment of the invention, each coprocessor 106 to 112 (FIG. 1) is arranged to carry out a modular multiplication using the look-ahead algorithm set forth in DE 36 31 992 C2.

A modular multiplication necessary therefore will be elucidated by way of FIG. 4b. The task is to multiply the binary numbers “111” and “101” with each other. To this end, this multiplication is carried out in a coprocessor, analogously to a multiplication of two numbers in accordance with known “school mathematics”, however, with the numbers being represented in binary form. For simplicity of illustration, the case considered hereinafter does not make use of a look-ahead algorithm, nor of a modulo reduction. In carrying out this algorithm, a first partial product “111” results first. This partial product, for consideration of the significance thereof, is then shifted one Position to the left. The first, left-shifted partial product, which may be understood as first intermediate result of a first iteration step, then has the second partial product “000” added thereto in a second iteration step. The result of this addition again is shifted one Position to the left. The shifted result of this addition then is the updated intermediate result. This updated intermediate result then has the last partial product “111” added thereto. The result obtained then is the final result of the multiplication. It is to be noted that the multiplication was split into two additions and two shift operations.

It is to be noted, furthermore, that the multiplicand M represents the partial product if the position considered of the multiplier is a binary “1”. In contrast thereto, the partial product is 0, if the position considered of the multiplier is a binary “0”. Furthermore, due to the respective shift operations, the positions or significances of the partial products are taken into consideration. This is shown in FIG. 4b by way of the shifted plotting of the partial products. As regards the hardware, the addition of FIG. 4b requires two registers Z₁ and Z₂. The first partial product could be stored in register Z1 and then be shifted one bit to the left in this register. The second partial product could be stored in register Z₂. The subtotal then could be stored again in register Z₁ and again be shifted one bit to the left. The third partial product would be stored in register Z₂ again. The final result would then be contained in register Z₁.

A schematic flow chart for the process illustrated in FIG. 4b is shown in FIG. 4a. In a step S10, the registers present in a coprocessor are first initialized. In step S12 following initialization, a three-operand addition is carried out in order to compute the first partial product. It is to be pointed out that, for the simple example given in FIG. 4b, which is a multiplication without modulo Operation, the equation indicated in step S12 would comprise Z, aₗ and P₁ only. al may be referred to as first look-ahead parameter. In its simplest form, “a” has a value of “1” if the respective position of the multiplier 0 is a 1. “a” is zero, if the respective position of the multiplier is a zero.

The operation illustrated in block S12 is carried out in parallel for all e.g. 1024 bits. Thereafter, in a step S14, there is carried in the simplest case a shift operation by one position to the right, in order to take into consideration that the most significant bit of the 2nd partial product is arranged one position lower than the most significant bit of the first partial product. If several consecutive bits of the multiplier O have a zero, a shift by several positions to the right will take place. Finally, in a step S16, the parallel three-operand addition is carried out again using e.g. the adder chain indicated in FIG. 3.

This process is continued until all e.g. 1024 partial products have been added up. Serial/parallel thus means the parallel implementation in block S12 or S16, and the serial processing to successively combine all partial products with each other.

In the following, reference will be made to FIGS. 5 to 7 in 25 order to give some examples as to how an operation may be split into specific partial operations. FIG. 5 depicts the operation x^{d} mod N. For breaking down this modular exponentiation, exponent d is represented in binary form. As shown in FIG. 5, this results in a chain of modular multiplications in which, as shown in FIG. 5 as well, each modular individual operation may be assigned to one coprocessor each, such that that all modular operations are carried out in parallel by the cryptographic processor shown in FIG. 1. The intermediate results then obtained, after having been ascertained in parallel, then are multiplied with each other in order to obtain the result. CPU 102 controls the splitting to the individual coprocessors CP₁ to CPₖ and then the final multiplication of the intermediate results with each other.

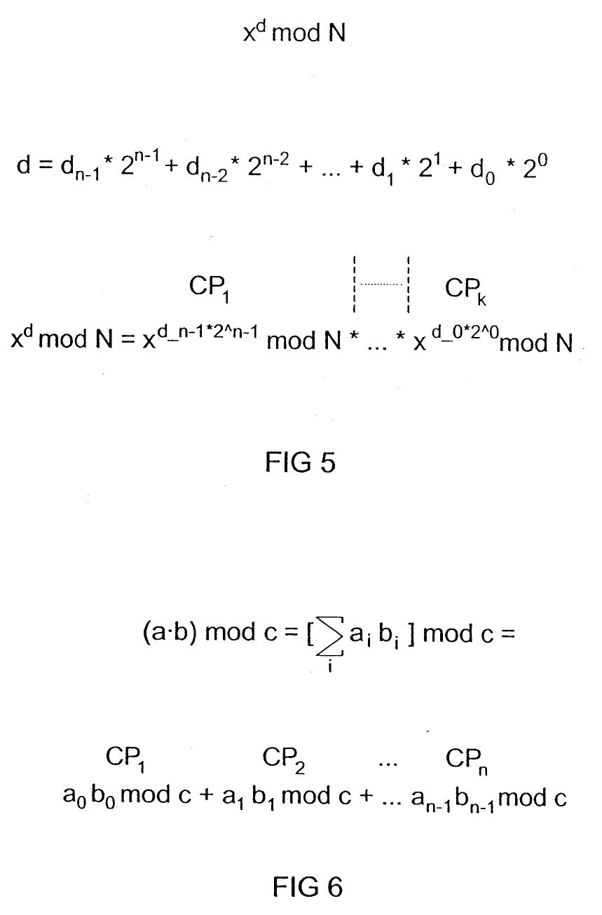

FIG. 6 illustrates another example of splitting an Operation (a*b) mod c into a plurality of modular operations. Coprocessor CP₁ again may ascertain a first intermediate result. The coprocessors CP₂ to CPₙ also compute intermediate results where after, after obtaining the intermediate 0 results, the CPU 102 controls the multiplication of the intermediate results with each other. The CPU controls the summing up e.g. such that it selects a coprocessor that is then fed with the intermediate results for summing up the same. Here too, an operation is split into several mutually independent partial operations.

It is to be pointed out that there are many possibilities of splitting the one or other operation into partial operations. The examples given in FIGS. 5 and 6 just serve for illustration of the possibilities of splitting one operation into a plurality of partial operations: there may indeed be more favorable types of splitting with respect to the performance attainable. Thus, it is not the performance of the processor that is essential in the examples, but that splittings are present so that each coprocessor carries out an independent partial operation, and that a plurality of coprocessors is controlled by a central processing unit in order to obtain an as obscured as possible current profile at the power input to the chip.

What is claimed is:

1. A cryptographic processor for performing operations for cryptographic applications, comprising:
a plurality of coprocessors, each coprocessor having a control unit, an arithmetic unit and a plurality of registers exclusively associated with said arithmetic unit of the respective coprocessor, each coprocessor having a word length which is predetermined by the number width of the respective arithmetic unit;
a central processing unit for controlling said plurality of coprocessors, said central processing unit being arranged to couple at least two coprocessors in such a way that the registers exclusively associated with them are interconnected so that the coupled coprocessors can perform a calculation with numbers the word length of which equals the sum of the number widths of said arithmetic units of said coupled coprocessors; and
a bus for connecting each coprocessor to the central processing unit,
said central processing unit, said plurality of coprocessors and said bus being integrated on one single chip, and
said chip having a common power supply terminal for feeding said plurality of coprocessors.

2. A cryptographic processor according to claim 1, wherein each coprocessor of said plurality of coprocessors is provided for a type of cryptographic algorithms of its own, so that the cryptographic processor is implemented in terms of hardware for a plurality of cryptographic algorithms.

3. A cryptographic processor according to claim 1, wherein said plurality of coprocessors comprises individual groups of coprocessors connected in parallel, each of said group of coprocessors being provided for a type of cryptographic algorithm of its own, so that the cryptographic processor is suitable for a plurality of cryptographic algorithms.

4. A cryptographic processor according to claim 2, wherein the type of cryptographic algorithms is selected from a group having the following members:
DES algorithm, AES algorithm for symmetric encryption processes, RSA algorithm for asymmetric encryption processes and Hash algorithm for computing Hash values.

5. A cryptographic processor according to claim 1, wherein a cryptographic operation can be split into a plurality of partial operations, the central processing unit being arranged to distribute the plurality of partial operations to individual coprocessors of said plurality of coprocessors.

6. A cryptographic processor according to claim 1, wherein the coprocessors are different from each other such that the number of different mathematical operations which the cryptographic processor is capable of carrying out in terms of hardware, is at least equal to the number of coprocessors.

7. A cryptographic processor according to claim 1, wherein the operations for cryptographic applications comprise modular exponentiation and/or modular multiplication and/or modular addition/subtraction.

8. A cryptographic processor according to claim 1, wherein each coprocessor is arranged to process binary numbers having at least 160 positions and preferably at least 1024 or 2048 positions.

9. A cryptographic processor according to claim 1, further comprising only one memory associated with the central processing unit.

10. A cryptographic processor according to claim 1, further comprising a clock generating means for delivering a clock to said processing unit and said plurality of coprocessors, said clock generating means being integrated on said single chip as well.

11. A processor according to claim 1, wherein the length of said plurality of registers associated with one coprocessor as well as the length of said plurality of registers associated with another coprocessor are different from each other such that the coprocessors are capable of carrying out arithmetic computations with numbers of different lengths each.

12. A cryptographic processor according to claim 1, wherein the number of registers associated with one coprocessor is sufficient to hold operands for at least two partial operations, so that for at least two partial operations it is not necessary to transfer operands between the coprocessors and said central processing unit.

13. A cryptographic processor according to claim 12, wherein said central processing unit further comprises a means for time control of the operation of the coprocessors, such that the sequence of said at least two partial operations, whose operations are stored in the registers of one coprocessor, is adjustable.

14. A cryptographic processor according to claim 1, further comprising a means for deactivating a coprocessor if the central processing unit determines that there are no partial operations present for said coprocessor, in order to reduce the power consumption of the cryptographic processor.

15. A cryptographic processor according to claim 1, wherein the central processing means is arranged to connect at least two coprocessors to a cluster, such that a partial operation is assigned to the cluster so that a partial operation can be carried out by the coprocessors of the cluster jointly.

16. A cryptographic processor according to claim 1, wherein the arithmetic unit of at least one coprocessor has a serial/parallel arithmetic-logic unit which is designed such that a number of computations can be carried out in parallel in one cycle, said number being equal to the positions of a number used in the computation, and in another, subsequent cycle, the same computation as in the first cycle is carried out in serial manner, using the result of said one cycle.

17. A cryptographic processor according to claim 16, wherein a coprocessor is designed for modular multiplication, in order to add, in one cycle, a partial product to a result of a previous cycle, and in order to add, in an additional cycle, the result of the last cycle to a next partial product.

18. A cryptographic processor according to claim 17, wherein the arithmetic unit comprises a three-operand adder for modular multiplication, which for each position of a number being processed comprises:
a half-adder for addition without a carry, having three inputs and two outputs; and
a subsequent full adder having two inputs and one output.

19. A cryptographic processor according to claim 1,
wherein the central processing unit comprises a means for controlling a crypto coprocessor for performing a dummy computation.

20. A cryptographic processor according to claim 16, wherein said means for controlling dummy computations is arranged to randomly select the cryptographic processor performing a dummy computation.
